(19) United States
(12) Patent Application Publication
(10) Pub. No.: US 2010/0258603 A1
(43) Pub. Date: Oct. 14, 2010

(54) Mouth call carrying apparatus

(76) Inventor: Jason Kent Swanson, Hershey, NE (US)

Correspondence Address: JASON KENT SWANSON, 19898 W WILDLIFE ROAD, HERSHEY, NE, 69101, US

(21) Appl. No.: 12/386,219

(22) Filed: Apr. 14, 2009

(51) Int. Cl. A45F 3/14; A01M 31/00

(52) U.S. Cl. 224/604; 224/247; 224/605

(57) ABSTRACT

A Mouth Call Carrying Apparatus comprises of a lanyard having spring loaded clamps attached thereon; wherein the spring loaded clamps readily accept and secure any type of mouth call; thus, enabling the user to easily access a mouth call; furthermore, enabling the user to keep a number of mouth calls readily available without having to search through pockets, pouches, and other carrying devices.

### CROSS-REFERENCE TO RELATED APPLICATIONS

Not Applicable

### FEDERALLY SPONSORED RESEARCH/DEVELOPMENT

Not Applicable

### SEQUENCE LISTING REFERENCE

Not Applicable

### BACKGROUND OF INVENTION

Game call lanyards are used by hunters. The ability to have a number of calls readily available is very effective when calling game animals. Although, there are a wide variety of lanyards available to hunters, they are all designed to accept only one type of call, i.e. tubular bodied reed calls. No lanyard has ever been designed to readily accept and secure diaphragm mouth calls.

Diaphragm mouth calls are primarily used by those who hunt big game, i.e. turkey, elk, deer, etc. Anyone who has ever used a mouth call knows how effective they are. Those same people also know the disadvantages of mouth calls. The nature of the call's design make it the smallest call used by hunters; therefore, they are easily lost and difficult to handle, especially, when wearing gloves; and due to the delicate materials used the call is easily damaged.

### BRIEF SUMMARY OF INVENTION

The present invention offers the first ever lanyard for diaphragm mouth calls. The present invention enables the user to have those same advantages known throughout history with game call lanyards.

The present invention enables the user to interchangeably use a number of calls with a single hand; in fact the call never has to be touched by the user's hand, it can be placed into and taken out of the user's mouth with the spring loaded clamp that grabs and holds the mouth call.

The present invention also keeps the call safe and secured; therefore, the call is not damaged and/or lost.

### BRIEF DESCRIPTION OF DRAWING VIEWS

FIG. 1 A front plane view of lanyard 10A according to the present invention.

FIG. 2 A perspective view of lanyard-drop 10B

FIG. 3 A side plane view of clamp 9

FIG. 4 A front plane view of lanyard 10A having a number of lanyard-drops 10B attached thereto

### DETAILED DESCRIPTION OF THE PRESENT INVENTION

The description given herein describes the present invention “mouth call carrying apparatus” in general. By no means is the design given herein absolute. The present invention in which this patent application describes is a basic design. A wide variety of materials and application thereof may be used to achieve the same results in which this application claims as new and useful.

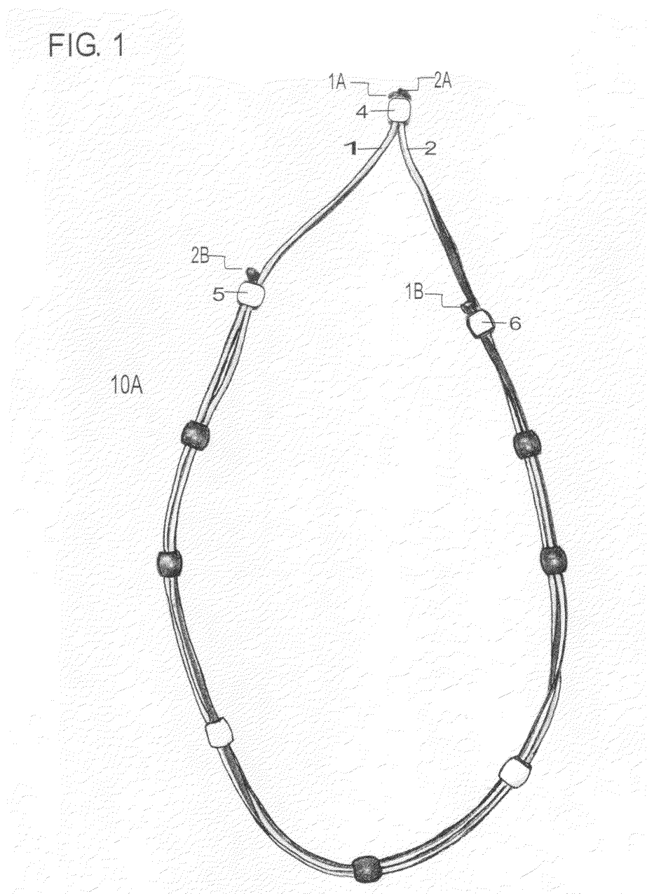

Referring FIG. 1, all components identified in FIG. 1, together are referred to as lanyard 10A. Strap 1 and 2 are of equal length; therefore, strap 1 is placed offset to strap 2.

Strap 1 has a first end 1A and a second end 1B. Strap 1's first end 1A passes through bead 4. Strap end 1A is knotted and/or melted to ensure strap end 1A does not pass back through bead 4. Strap l's second end 1 B passes through bead 5. Strap end 1B passes through bead 6. Strap end 1B is knotted and/or melted to ensure strap end 1B does not pass back through bead 6.

Strap 2 has a first end 2A and a second end 2B. Strap 2's first end 2A passes thru bead 4. Strap end 2A is knotted and/or melted to ensure strap end 2A does not pass back through bead 4. Strap end 2B passes through bead 6. Strap end 2B passes through bead 5. Strap end 2B is knotted and/or melted to ensure strap end 2B does not pass back through bead 5.

Bead 4, 5, and 6 move freely along strap 1 and 2; thereby, adjusting the length of lanyard 10A.

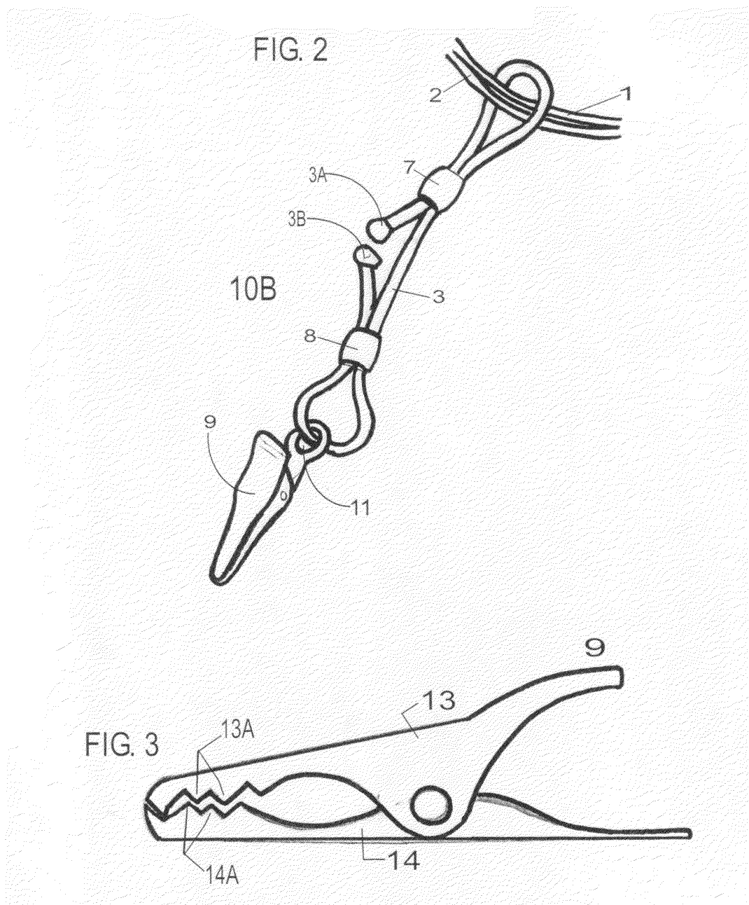

Referring to FIG. 2; all components identified in FIG. 2, together are referred to as lanyard-drop 10B.

Strap 3 has a first end 3A and a second end 3B. Strap end 3A passes thru bead 7. Strap end 3A is placed around strap 1 and 2. Strap end 3A passes back thru bead 7. Strap end 3A is knotted and/or melted to ensure strap end 3A does not pass back through bead 7.

Strap 3's second end 3B passes through bead 8. Strap end 3B passes through ring 11, located at the back of clamp 9's lower jaw. Strap end 3B passes back through bead 8. Strap end 3B is knotted and/or melted to ensure strap end 2B does not pass back through bead 8.

Bead 7 and bead 8 slide along strap 3; thereby, adjusting the length of lanyard-drop 10B.

Referring to FIG. 3; clamp 9 has a jagged edge 13A along the bottom of clamp 9's top jaw 13. Clamp 9 has a jagged edge 14A on the top side of clamp 9's lower jaw 14.

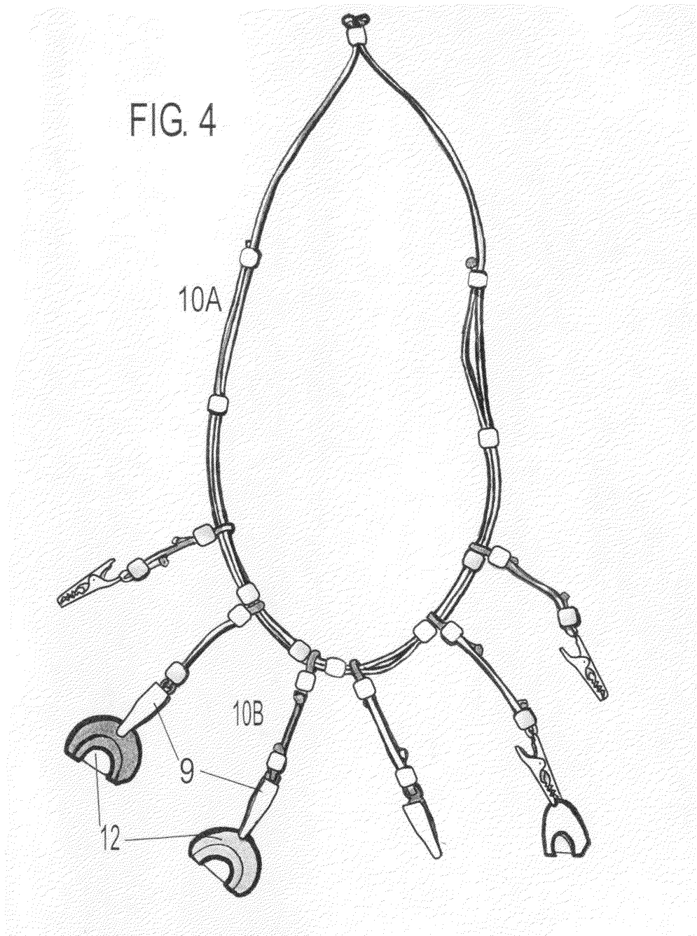

Referring to FIG. 4; lanyard 10A has a multiple number of lanyard-drops 10B attached thereon. A mouth call 12 is secured by clamp 9 of lanyard-drop 10B.

1. Mouth Call Carrying Apparatus comprising;
a string having a first end and a second end;
means for attaching said first end with said second end;
a spring loaded clamp;
means for attaching said clamp to said string at any point between said first end and said second end; wherein said clamp readily accepts and secures any type diaphragm mouth call.

2. A Mouth Call Carrying Apparatus according to claim 1: wherein a multiple number of spring-loaded clamps may be attached to said string; thus, allowing the user to carry a multiple number of mouth calls.

3. A Mouth Call Carrying Apparatus according to claim 1: wherein said clamp has ridges along the bottom edge of the top jaw and ridges along the top edge of the bottom jaw; thus, having a secured grip on the mouth call.
